(19) United States
(12) Patent Application Publication
(10) Pub. No.: US 2009/0127250 A1
(43) Pub. Date: May 21, 2009

(54) Portable Body Joint Electric Heating Pad Fabric

(76) Inventor: Pang-Hua Chang, Taipei City (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/944,310

(22) Filed: Nov. 21, 2007

(51) Int. Cl. H05B 3/34

(52) U.S. Cl. 219/529

(57) ABSTRACT

A portable human body joint electric heating pad, used to apply heat on the local sore joint of human body continuously to contribute blood circulation thereof, characterized in (1) a stainless synthetic fiber which is provided with rapid electric conduction and heat conduction capabilities and converts electric energy into thermal energy. It is also provided with Velcro® fabric fastener for the convenience of covering body parts; (2) a finger cover hole which have said stainless synthetic fiber fit the finger of the user to cover on the hand more stably; (3) an USB power supply line which connects on said carbon fiber electric conduction fabric and inserts into an USB slot, i.e., supplying the required electric energy; (4) an extension band which is a kind of elastic fabric band to stick on said stainless synthetic fiber via the Velcro® fabric at one end to achieve the goal of length extension.

### FIELD OF THE INVENTION

The present invention relates to a portable body joint electric heating pad fabric which produces a body endurable temperature that uniformly distributes throughout the entire pad fabric by means of a low voltage. This pad fabric can be wound around sore joint region of human body to apply heat to sore joints, and to increase blood circulation of said joint region to alleviate the sore feeling accordingly.

### DESCRIPTION OF THE PRIOR ART

Regarding the after treatment of injured joints in medical science, it is typical to apply heated electric fabric to the joint region with high temperature fabric in order to increase blood circulation, hasten recovery speed and reduce pain. However, these treatments are usually for serious traumas or sports injuries and since the injury areas are larger, the heating pad is typically larger as well. Correspondingly, the required electric energy has to be relatively large, and as a result typical heated fabric has to be connected with a general power supply (e.g., AC/DC power source from a wall socket) for use. Considering that in contemporary societies people have busy lives and generally lack exercise, making them more susceptible to straining injuries. When the injury is not serious enough to require hospital treatment, pain can be reduced by applying heat for a certain amount of time. Among the general heating application methods, the conventional towel heating application is portable and does not affect the mobility of the patient, but the heating application effect is short-lived. On the other hand, a typical medical electric heating pad is too expensive and lacks mobile convenience. Also known are heating ointment pad that has medical effects, but it is susceptible to skin allergies or dermatitis. Naturally, some people choose natural medication method to have the injured region recover slowly and naturally on its own, but the slow process affects daily activities and can increase the risk of secondary injury.

There are some small electric heating pads merely useful to apply on the limbs of the body, and need to be connected to the household power supply to have the electric heating effect. Therefore, the user has to interrupt the work at hand in exchange for having the opportunity of heating application. In the past, heating pads also produce electromagnetic waves during the electric heating process. Though the sore region can be improved by the electromagnetic waves, the body also undesirably absorbs a lot of electromagnetic waves.

### SUMMARY OF THE INVENTION

The inventive motive of the present invention is considering that people in contemporary societies are busy at work and in life, and lack exercise. As a result, each joint region of the body is susceptible to soreness or unexpected strain which affects the work efficiency. To alleviate the unwanted effects brought by these problems, a portable body joint electric heating pad is invented to fulfill unmet needs in the conventional heating application method.

The present invention is a portable body joint electric heating pad fabric which can be heatedly applied on the local sore joint of body over time to increase blood circulation thereof, and characterized in (1) a stainless synthetic fiber which converts electric energy into heat energy, (2) a finger cover hole which enables the present invention to cover on the user's hand more stably, (3) an USB power supply line which connects to said carbon fiber electric conduction fabric and inserts into a USB slot, i.e., supplying the required electric energy, (4) an extension band which is an elastic fabric band to be carried on any region of body easily.

The present invention cooperates with a UBS battery box device for use. Additionally, it enables a user to apply heat continuously outdoors, where there is no electrical outlet. It increases the mobility which conventional products lack. Furthermore, it can be used as a mobile warmth-keeping device in the outdoors when the weather is cold.

### BRIEF DESCRIPTION OF THE DRAWINGS

The drawings disclose an illustrative embodiment of the present invention which serves to exemplify the various advantages and objects hereof, and are as follows:

FIG. 1 is a schematic diagram of the present invention combing with different power supply;

FIG. 2 is a winding schematic diagram of the present invention heatedly applied on the hand region;

FIG. 3 is schematic diagram of the present invention heatedly applied on the arm;

FIG. 4 is a schematic diagram of the present invention heatedly applied on the shoulder and back region.

FIG. 5 is a schematic diagram of the present invention heatedly applied on the neck region.

### DETAILED DESCRIPTION OF THE PREFERRED EMBODIMENT

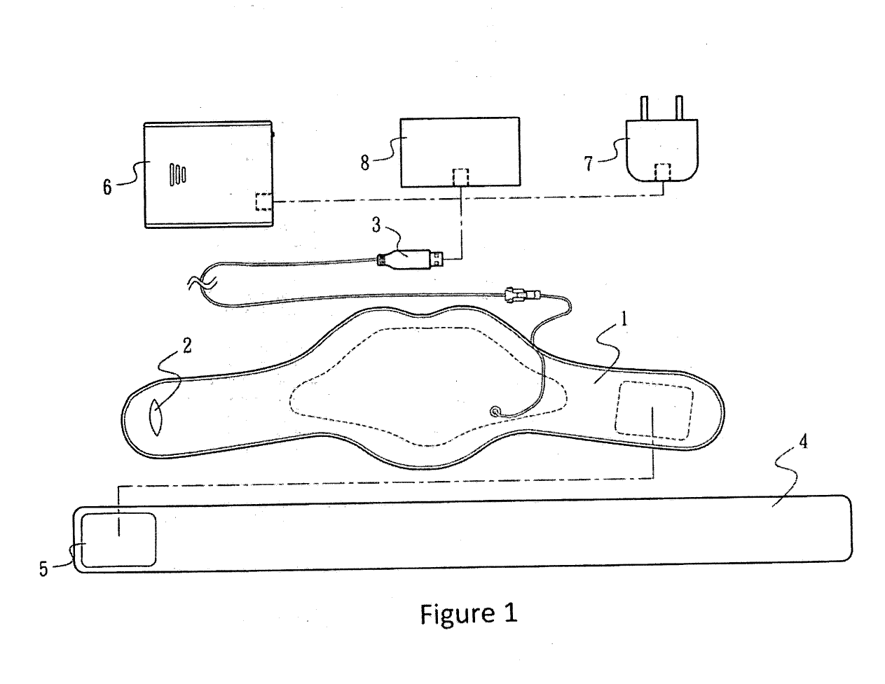

The present invention is a portable human body joint electric heating pad fabric which is capable of applying heat on the sore joint region of body over time. As shown in FIG. 1 it is characterized in a stainless synthetic fiber (1) which is provided with rapid electric conduction and heat conduction capabilities and converts electric energy into heat energy. It is provided with Velcro® fabric at one end to have the stainless synthetic fiber (1) with winding and fixing functions; a finger cover hole (2) which is a tiny hole at the end of the stainless synthetic fiber (1) to have the stainless synthetic fiber (1) hang on one finger of the user; an USB power supply line (3) which is connected to the carbon fiber electric conduction fabric (1) and inserted into an USB slot, i.e., supplying the required electric energy of the present invention; an extension band (4) which is an elastic fabric band with extension length to stick on the stainless synthetic fiber (1) via the Velcro® design at one end to achieve the goal of length extension.

The stainless synthetic fiber (1) of the present invention is made by nanotechnology and cooperates with a fireproof and less-heat dissipation fabric. It does not need to worry about the problem of catching fire and the stainless synthetic fiber (1) is provided with far-infrared ray function to achieve additional effect to apply heat to limbs of the user to shorten or lessen the time of recovery. Additionally, during the power supply process the contemplated stainless synthetic fiber (1) not only produces low electromagnetic waves but also has an anti-electromagnetic wave function. This is possible because the technology used here to convert electric energy into thermal energy (heat) uses a low power supply (relatively low level of electrical current). It decreases undesired spillover of electromagnetic waves during the conversion of electronic energy into thermal energy. Hence, the effect of electromagnetic waves on user's body is lessened.

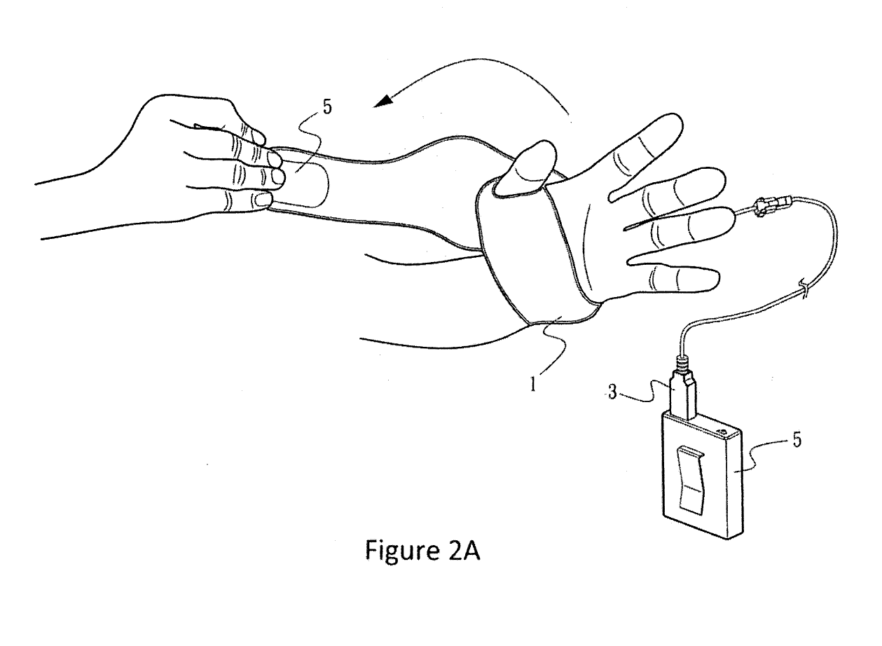

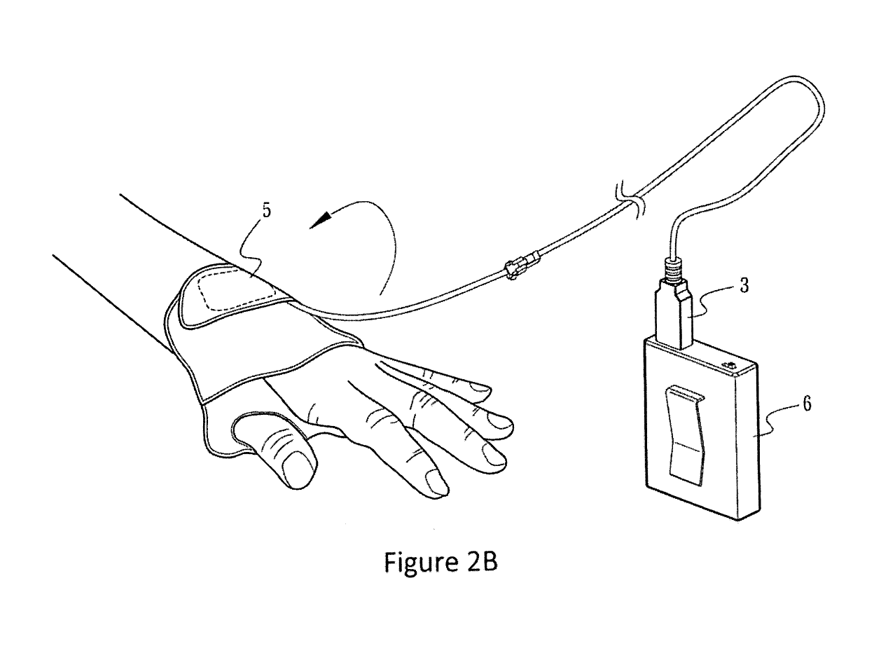

The prominent feature of the present invention is that heat can be applied to the whole hand. As shown in (A) and (B) of FIG. 2, they are difficult to perform for conventional electric heating application products. Firstly, as shown in (A) of FIG. 2, thumb enters the finger cover hole (2) of the present invention and the stainless synthetic fiber (1) is wound in a circle from the palm toward the back of the hand following the direction of the arrow, and wound again in the same direction. Finally the Velcro® fiber (5) is stuck on the stainless synthetic fiber (1) of the back of hand. As shown in (B) of FIG. 2 by means of the power supply of an USB battery box device (6), heat can be applied to the back of hand and wrist joint without affecting the original mobility of the hand. Furthermore, the fingers can still grasp articles. If the stainless synthetic fiber (1) is wound in opposite direction, heat can be applied to the palm and wrist joint.

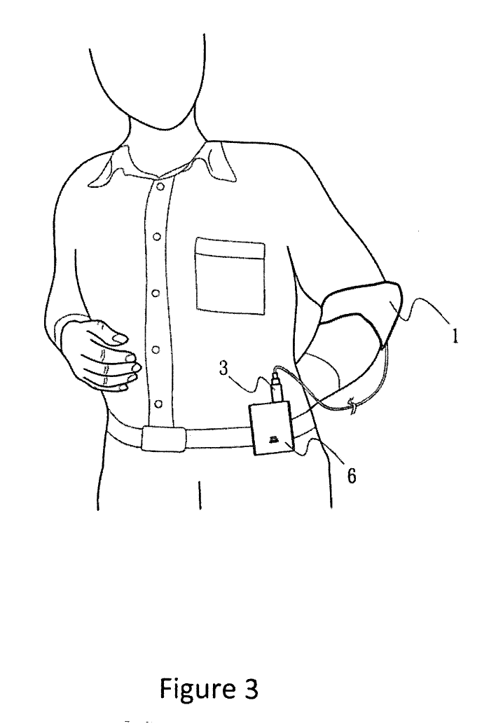

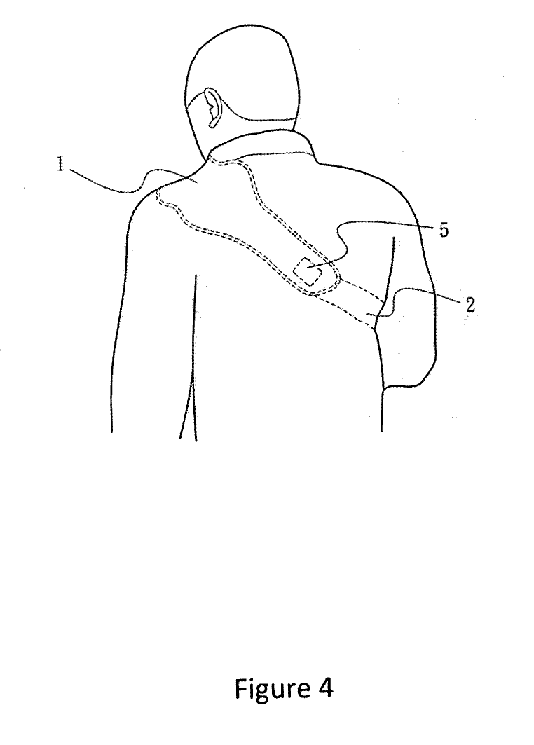

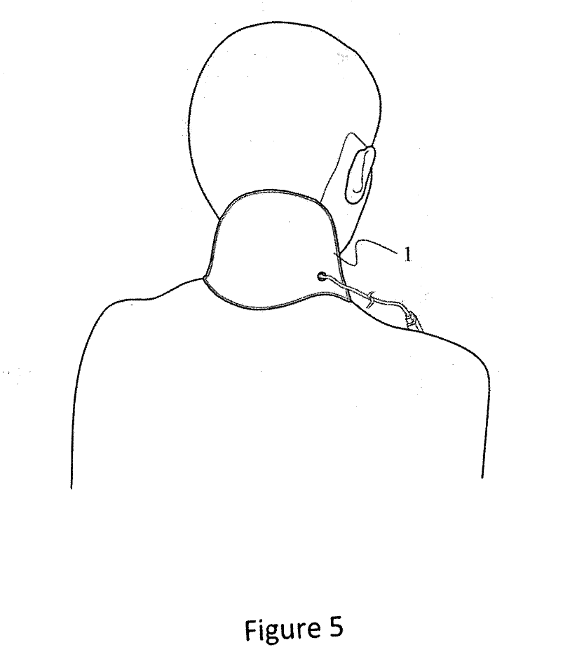

As shown in FIG. 3, FIG. 4 and FIG. 5, the present invention can apply heat on other regions of the human body. The stainless synthetic fiber (1) is wound around the arm and cooperated with the USB battery box device (6) to have heating application effect on arm and elbow joint. As shown in FIG. 3, user is not limited by the length of the USB power supply line (3) to change the original standing gesture. For the same reason, it can apply heat to the foot and knee joint. If shoulder joint is sore and needs heating application to alleviate the discomfort feeling, the Velcro® fiber (5) at one end of the extension band (4) can be stuck with the stainless synthetic fiber (1) of the finger cover hole (2) at the other end to increase the original length of stainless synthetic fiber (1). By means of obliquely bearing method the stainless synthetic fiber (1) is tightly fastened on the shoulder region and the extension band (4) is wound around the other side of the armpit of the user's body to have one end of Velcro® fiber (5) of the stainless synthetic fiber (1) stuck on the extension band (4). Accordingly, the stainless synthetic fiber (1) is fixed at the shoulder and back region. As shown in FIG. 4, it does not affect dress and clothes of the user. For the same reason, the present invention can be wound around and fixed at the waist or back or other region to have heat applied to other sore regions. The length of stainless synthetic fiber (1) alone can be wound around the neck to have heat applied to neck joint. As shown in FIG. 5, it can be used as an electric heating scarf in cold weather.

The stainless synthetic fiber (1) of the present invention includes a temperature sensor chip to control the heat of the stainless synthetic fiber (1) over time. The generated heat is held within a certain range of temperature so as to prevent accumulating temperature which may cause overheating and fire. Additionally, by means of low power technology the electric energy is converted into thermal energy. It lowers electromagnetic wave generation, which may endanger human health, to provide higher safety during use. As shown in FIG. 1 the present invention provides three types of power supply method:

The first type: the USB power supply line (3) is inserted into a slot of USB battery box device (6) to be provided with electric energy by the battery therein;
the second type: the USB power supply line (3) is inserted into an alternating current adaptor (7) to be provided with electric energy by the general alternating current;
the third type: the USB power supply line (3) is inserted into a personal computer (8) or notebook to be provided with electric energy by computer. Although a USB cord is specifically mentioned here, other connector types are also contemplated.

The selection of the abovementioned three types of power supply methods depends on the user environment. Wherein the first type is provides higher mobility, the second type is suitable for the environment where the body does not need to move around or the user has to lie down. The third type is suitable for users working on a computer and would wish to continue working on the computer.

Additionally, if the USB power supply line (3) and stainless synthetic fiber (1) are made by water resistant material, the present invention can be cleaned with water. Surely when the weather is cold, the stainless synthetic fiber (1) and the extension band (4) can cooperate together to tie around the body to provide warmth locally. Furthermore, a container with small specific heat coefficient like a cup made by metal can be covered in winding to keep the liquid therein at a constant temperature to enable user to drink warm beverage.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A portable body joint electric heating pad fabric used to apply heatedly on the sore joint region of body, characterized in:
a stainless synthetic fiber, said fabric is a soft fabric weaved by nanotechnology and is provided with rapid electric conduction and heat conduction capabilities and converts electric energy into heat energy wherein one end is provided with Velcro fabric to have said stainless synthetic fiber with winding and fixing functions;
a finger cover hole, said finger cover hole is a small hole at one end of said stainless synthetic fiber to have said stainless synthetic fiber hung on a finger of user;
an USB power supply line connected to said fiberglass conductive fiber and plugged into an USB slot, i.e. providing the electric energy required by said portable body joint electric heating pad fabric;
an extension band with extension length and elasticity, wherein a Velcro fabric design is provided at one end to stick;
wherein said stainless synthetic fiber is provided with a finger cover hole at one end and an USB power supply line is provided at the other end as the source of electric energy to achieve the goal of length extension via the Velcro fabric and the extension band.

2. A portable body joint electric heating pad fabric according to claim 1, said stainless synthetic fiber is a fabric which is fireproof and less heat dissipated.

3. A portable body joint electric heating pad fabric according to claim 1, said stainless synthetic fiber is provided with far-infrared ray function during the power supply process to further increase the heating application effect on limbs.

4. A portable body joint electric heating pad fabric according to claim 1, said stainless synthetic fiber is provided with anti-electromagnetic wave function to lower the spillover of generated electromagnetic wave during the conversion of electric energy into heat energy.

5. A portable body joint electric heating pad fabric according to claim 1, said finger cover hole and said stainless synthetic fiber, especially at the palm region are more securely wound around to provide better heating application effect on palm region.

6. A portable body joint electric heating pad fabric according to claim 1, said extension band is stuck with said stainless synthetic fiber by the use of the Velcro fabric to achieve the goal of winding and fixing said portable body joint electric heating pad fabric at the waist or back.

7. A portable body joint electric heating pad fabric according to claim 1, said stainless synthetic fiber decreases the generation of electromagnetic wave during the conversion of electricity energy into heat energy by means of low power conversion technology.

8. A portable body joint electric heating pad fabric according to claim 1, it is provided with three types of power supply methods:
a first type: said USB power supply line is inserted into the slot of USB battery box device to be provided with electric energy by the battery therein;
a second type: said USB power supply line is inserted into an alternating current adaptor to be provided with electric energy by the general alternating current;
a third type: said USB power supply line is inserted into a personal computer or notebook to be provided with electric energy by computer;
the selection of the abovementioned three types of power supply methods depends on the user environment.

9. A portable body joint electric heating pad fabric according to claim 1, said stainless synthetic fiber includes a temperature sensor chip to control the heat of said stainless synthetic fiber continuously within a certain range of temperature.

10. A portable body joint electric heating pad fabric according to claim 1, said USB power supply line and said stainless synthetic fiber are a kind of water resistant material to have said portable body joint electric heating pad fabric with water cleaning feature.

11. A portable body joint electric heating pad fabric according to claim 1, said stainless synthetic fiber is cooperated with said extension band to increase the original length of said stainless synthetic fiber to tie around the body to keep warm locally.

12. A portable body joint electric heating pad fabric according to claim 1, said stainless synthetic fiber is wound around the neck to work as an electric heating neckerchief.

13. A portable body joint electric heating pad fabric according to claim 1, a cup with small specific heat coefficient is covered in winding to have the liquid therein maintain a constant temperature.
